(19) United States
(12) Patent Application Publication
(10) Pub. No.: US 2002/0122429 A1
(43) Pub. Date: Sep. 5, 2002

(54) Mechanism and method for user selection of dynamic quality of service in telephony

(76) Inventor: Theodore Leon Griggs, Woodside, CA (US)

Correspondence Address: Kenneth B. Paley, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/800,041

(22) Filed: Mar. 5, 2001

(51) Int. Cl. H04L 12/66; H04L 12/28; H04L 12/56

(52) U.S. Cl. 370/401; 370/352

(57) ABSTRACT

A method and apparatus to dynamically change the quality of service level of a transmission over a network is disclosed. The method and apparatus each have a management unit that receives level of quality of service requests from user input devices coupled to network gateways, and commands a changed quality of service level for a call according to each request. In an embodiment, a billing application is coupled to the management unit in application and the management unit sends to the billing application data indicating the changed quality of service level of the call.

### FIELD OF THE INVENTION

The present invention relates generally to the field of packet-switched networking and more specifically to a method and apparatus to dynamically change the quality of service of a network transmitted call.

### BACKGROUND OF THE INVENTION

In a conventional telephone network, messages are transmitted on a circuit switched network having a dedicated line for transmission between the parties. During the duration of a call or connection no other call or connection can use the physical line. A circuit switched network has a fixed quality of service that is guaranteed by its transport layer.

In contrast in a packet network, messages are divided into units of data called a packet, which are individually transmitted over a physical path that can be shared by other users and connections. In consequence, packet switching is more efficient and robust than a telephone circuit switched network. A packet network call or connection may have a number of levels of quality of Service that are determined by settable capabilities in the packet transmission devices.

The packet transmission devices may include gateways, routers, and switches. A telephony gateway is a network element that provides conversion between the audio signals carried on telephone circuits and data packets carried over a packet network. In the Media Gateway Control Protocol (MGCP) model, the media gateways focus on the audio signal translation (or conversion) function, while the call agent implements the signaling layers of the H.323 standard.

Media device packet network architecture integrates a media device with a packet network gateway through a media interface integration circuit. In these networks, a management unit provides call control intelligence for the media device inputs to the network. The management unit is commonly called both a call agent and a software switch. A management unit may or may not be distributed over several computer platforms. The management unit may control the switching activity of network packet transmission devices, and in a telephony network may handle the call control function. The management unit may also set the quality of service of the network for a connection in accordance with a network protocol. In a protocol such as MGCP, the management unit may execute the functions of a media gateway controller, to guide the set-up and tear-down of a connection. The connection data path between the connection endpoint gateways is designated the bearer circuit (or bearer path) in MGCP terminology.

The management unit has an at least one network address, and is coupled to a media device through the media device gateway along an at least one data path designated a signaling circuit (or signaling path). In an embodiment having a telephone media device by way of example, the media interface integration circuit digitizes and packetizes the telephone signal. The media device gateway sends to the management unit a telephone tone frequency events such as both a hang up tone and a dialed number, along the signaling path. The management unit interprets a hang up tone as a signal to manage a tearing down of the connection. The management unit interprets a dialed number as a signal to create a bearer path for the connection.

As voice telephony, and multimedia services such as video conferencing, migrate from circuit switched networks to packet networks, the ability to provide flexible levels of quality of service become possible. Quality of service is of particular concern for the continuous transmission of high bandwidth video and multimedia information. For example, a 1.44 Mbit T-1 carrier digital line when used for voice communications in the Public Switched Telephone Network (PSTN), subdivides the bandwidth into 24 fixed 64 Kbit/second channels. The same T-1 carrier line when used for transmission of packetized data can divide up the available bandwidth in any number of ways. For instance, a T-1 carrier line can carry a number of heavily compressed voice streams at 8 Kbits/second as well as a high fidelity sound stream at 512 Kbits/second.

As used herein, the term “quality of service” refers to a measure of performance for a bearer path. The measure of performance can include at least one of an available capability, a variable capability, and a specific capability both guaranteed and not guaranteed, for a given transmission. Quality of service in a specific application can include the bandwidth of a transmission (within a range of tolerance that may be expressed by an average or a peak value), and/or the compression algorithm used to encode the data stream (codec). A transmission device quality of service is generally determined by the value of specific transmission device parameters (or characteristics). For bandwidth, these parameters may include at least one of an average packet transfer delay, a packet delay variation, a packet loss rate, and a transmission error rate. In the case of a transmission device having a plurality of quality of service levels, each quality of service level in a transmission device herein described are configurable, and can be set by an outside agent.

The connection between a receiving and sending media gateway can be whatever quality of service level the transmission devices that constitute the network can support. Although the levels of quality of service available over a packet network are very flexible, current implementations of voice and multimedia communications over packet networks mimic the inflexibility of a circuit switched network by setting the quality of service level only at the start of a call, and thus to a fixed level for the duration of a call. What is needed is a mechanism and method for dynamically setting the quality of service level so that a user can change a quality of service level during a call commensurate with felt user requirements. This will provide an efficient utilization of a network and provide a quality of service level that matches user demand.

### SUMMARY OF THE INVENTION

A method of changing a quality of service level of a network call between one endpoint gateway and another endpoint gateway, from an existing quality of service level to a changed quality of service level, includes a user input device coupled to the network sending a first signal to a management unit that is coupled to the network that indicates the changed quality of service level for the call. The management unit sends at least one second signal that indicates the existing quality of service level for the call in response to the first signal, to at least one network transmission device. The network configures a bearer path for the call that has the changed quality of service level in response to the management unit sending the at least one second signal.

In another embodiment, a method of changing a quality of service level of a call in a network between a first endpoint gateway and a second endpoint gateway configured to transmit a first quality of service level, to a changed quality of service level, including a management unit sending at least one first signal to at least one network transmission device that commands a re-configuration to transmit the call at the changed quality of service level between the first endpoint gateway and the second endpoint gateway, in response to the first signal.

In another embodiment, a network management unit includes a circuit to generate a signal to indicate a to be changed quality of service level for a call having a quality of service level between at least two network gateway endpoints; and a circuit to send the signal to the network to command the network to change the quality of service level to the to be changed quality of service level. In another embodiment, a machine-readable medium that provides instructions, which when executed by at least one processor, cause the processor to perform operations that include generating a signal to indicate a to be changed to quality of service level for a call having an existing quality of service level between at least two network gateway endpoints of a network; and sending the signal to the network to command the network to change the quality of service level from the existing quality of service level to the to be changed to quality of service level.

Other features of the present invention will be apparent from the accompanying drawings, from the detailed description that follows, and from the recited limitations of the claims.

### BRIEF DESCRIPTION OF THE DRAWINGS

The present invention is illustrated by way of example and not limitation in the figures of the accompanying drawings, in which like references indicate similar elements.

FIG. 1 is a block diagram of an illustrative data network coupled to an embodiment of a management unit.

FIG. 2 is a flow chart of an embodiment of a method and a mechanism for dynamically selecting a quality of service level, using as a reference the data network portrayed in FIG. 1.

### DETAILED DESCRIPTION

In the following description, various aspects, configurations, and details of the present invention will be described. However, it will be apparent to those skilled in the art that the present invention may be practiced with only some or all aspects, configurations, and details of the description. In other instances, well known features are omitted or simplified, including apparatus and method steps, in order not to obscure the present invention. Various operations will be described as multiple discrete steps performed in turn in a manner that is most helpful in understanding the present invention. However, the order of description should not be construed as to imply that these operations are necessarily order dependent, in particular, the order the steps are presented. Any necessary ordering is alternatively expressly mentioned or will be understood by those skilled in the art. Furthermore, the phrases “in one embodiment” and/or “an embodiment” are used repeatedly. However the phrases do not necessarily refer to the same embodiment, although they may.

The present invention also relates to apparatus including circuits for performing the operations herein. This apparatus may be specially constructed for the required purposes, or it may include a general purpose computer selectively activated or reconfigured by a computer program stored in the computer. Such a computer program may be stored in a computer readable storage medium. A machine readable storage medium includes any mechanism that provides (i.e. stores and/or transmits) information in a form readable by a machine (e.g. a computer). For example, a machine-readable medium includes read only memory (ROM), random access memory (RAM), magnetic disk storage media, optical storage media, flash memory devices, electrical, optical, acoustical or other form of propagated signals (e.g., carrier waves, infrared signals, digital signals, etc.), etc. The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

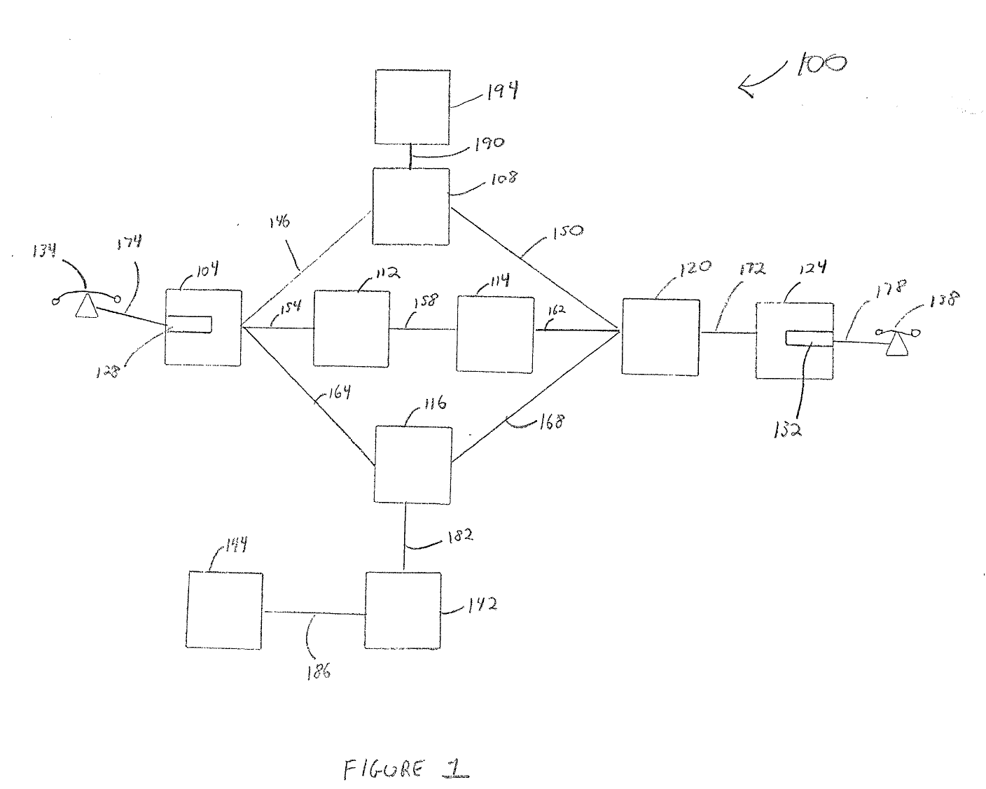

Referring to FIG. 1, a packet network 100 includes media device 134 implemented illustratively as a touch-tone telephone, coupled to the gateway 104 by a transmission path 174 and the call control user interface integration circuit 128. The interface integration circuit 128 in an embodiment is implemented on a circuit card disposed within the gateway 104 and coupled to both the media device 134 circuit and the gateway 104 circuit. The network 100 includes a gateway 124 and a media device 138 implemented illustratively as a telephone that is coupled to the gateway 124 by a transmission path 178 and an interface integration circuit 132. The interface integration circuit 132 which in an embodiment is implemented on a circuit card disposed within the gateway 124 and coupled to both the media device 138 circuit and the gateway 124 circuit. The network 100 also includes a gateway 108 and a user input device 194 implemented illustratively as a computer input device that is coupled to the gateway 108 by a transmission path 190.

The network 100 includes a management unit 142 to perform a conventional function of a management unit on the network 100, furthermore to dynamically set the quality of service of a call even as a transmission is going, and to send each quality of service level setting event to a billing application 144. The interface between the management unit 142 and the billing application 144 may be in an embodiment a standard interface well known to those skilled in the art of network telephony, or alternatively in an embodiment, an application specific interface. The management unit 142 is coupled to the transmission device 116 by a transmission path 182. In an embodiment, a management unit may be distributed over several computer platforms. The network 100 includes a billing application 144 that is coupled illustratively to the management unit 142 by the transmission path 186. The billing application 144 represents any application, device, method, or the like;

that generates or evaluates the quality if service history, bill, cost, charge, price, value of a call, or the like, well known to those skilled in the art of network telephony. In application herein, the billing application 144 may include in the quality of service history, bill, cost, charge, price, value of the call, or the like; the affect of a changed quality of service level because the management unit 142 sends a quality of service level setting event to the billing application 144.

The illustrative possible network bearer paths of network 100 between the gateway 104 and the gateway 124, include a first bearer path comprising transmission path 146, transmission device 108, transmission path 150, transmission device 120, and transmission path 172; a second bearer path comprising transmission path 154, transmission device 112, transmission path 158, transmission device 114, transmission path 162, transmission device 120, and transmission path 172; and a third bearer path comprising transmission path 164, transmission device 116, transmission path 168, transmission device 120, and transmission device path 172. The network signaling path from the media device gateway 104 to the management unit 142 comprises the transmission path 164, the transmission device 116, and the transmission path 182. The network signaling path from the gateway 108 to the management unit 142 comprises the transmission path 146, the gateway 104, the transmission path 164, the transmission device 116, and the transmission path 182. The network signaling path from the gateway 124 to the management unit 142 comprises the transmission path 172, the transmission device 120, the transmission path 168, the transmission device 116, and the transmission path 182.

Given illustrative quality of service levels 1, 2, 3, 4, and 5, in which a higher number indicates a higher quality of service level; it is illustratively presumed herein that the gateway 104 can transmit data at illustrative selectable quality of service level 1, level 2, level 3, and level 4; that transmission device 108 can transmit data at illustrative selectable quality of service level 1 and level 2; that transmission device 112 can transmit data at illustrative selectable quality of service level 1, level 2, and level 3; that transmission device 114 can transmit data at illustrative selectable quality of service level 1, level 2, level 3, and level 4; that transmission device 116 can transmit data at illustrative selectable quality of service level 1, level 2, level 3, level 4, and level 5; that transmission device 120 can transmit data at illustrative selectable quality of service level 1, level 2, level 3, and level 4; that the gateway 124 can transmit data at illustrative selectable quality of service level 1, level 2, level 3, level 4, and level 5; and that the transmission paths 146, 150, 154, 158, 162, 164, 168, and 172 do not materially impact the network 100 quality of service. It is illustratively presumed herein that a quality of service level for a given bearer path is as high as the lowest quality of Service level of a transmission path or transmission device in the data path.

Thus, according to the illustrative quality of service level capabilities of each of the transmission devices of the network 100, the quality of service levels of the first bearer path that includes the transmission devices 104, 108, 120, and 124 are level 1 and level 2, limited by the highest quality of service level of the transmission device 108 which is level 2. According to the illustrative quality of service level capabilities of each of the transmission devices of the network 100, the quality of service levels of the second bearer path that includes the transmission devices 104, 112, 114, 120, and 124 are level 1, level 2, and level 3, limited by the highest quality of service level of the transmission device 112 which is level 3. According to the illustrative quality of service level capabilities of each of the transmission devices of the network 100, the quality of service levels of the third bearer path that includes the transmission devices 104, 116, 120, and 124 are level 1, level 2, level 3, and level 4, limited by the highest quality of service level of the transmission devices 104 and 120 which is level 4.

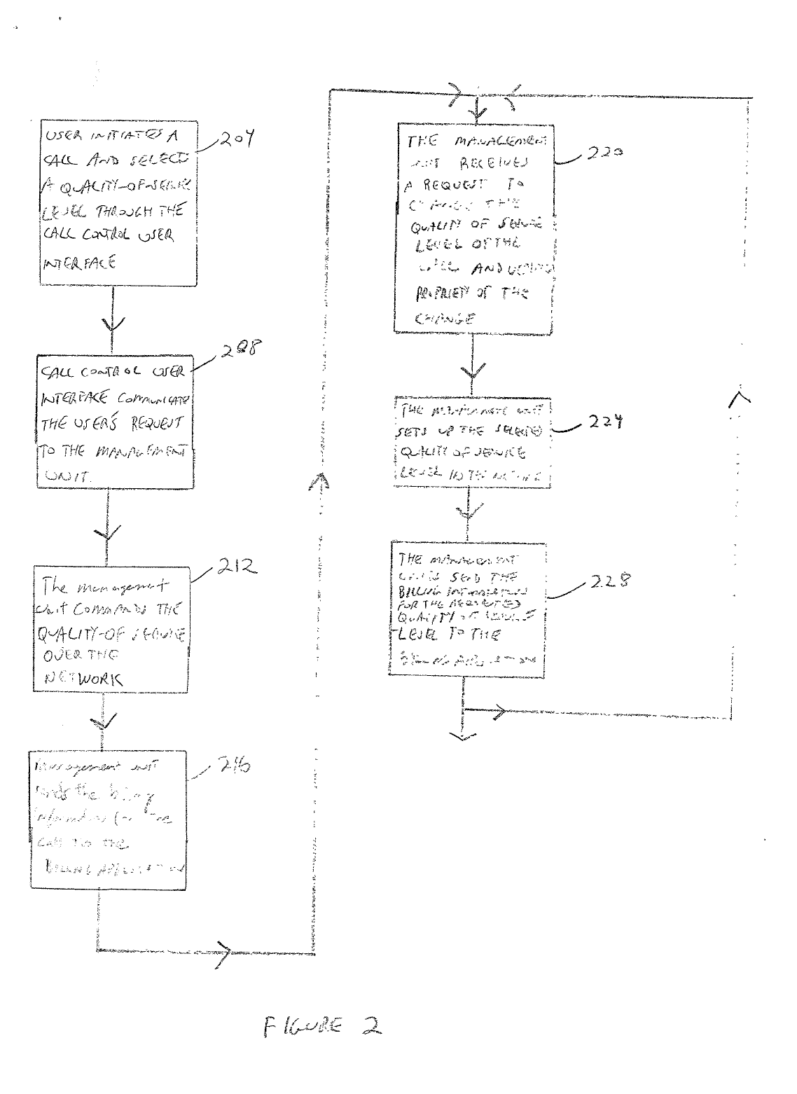

Referring now to both FIG. 1 and FIG. 2, in block 204 a user of the data network 100 initiates a call and requests a quality of service level for the call from a user input device. In the illustrative embodiment portrayed in FIG. 1, the touch-tone telephone media device is a user input device. In the example of a touch-tone telephone media device 124 user input device, the call may be initiated by the user keying a telephone number or other destination code into the touch-tone telephone touch-pad. The user may also request a quality of service level by keying a quality of service level code into the touch-tone telephone touch-pad. The touch-pad conventionally converts each touch-pad button selection (or combination thereof) into a tone having a frequency higher than the telephone call data content (e.g. a conversation), and is then separated from the call data content by the interface integration circuit 128, then converted to a binary format, and then transferred via a signaling path to the management unit 142. The telephone call data content is sent by the coupled gateway 104 along a bearer path to a receiving endpoint.

Alternatively, using a computer display or other user selection input device as a user input device, rather than a telephone touch-pad, for at least a portion of the source of data transferred to the management unit 142, the user transmits at least one of the destination code and requested quality of service in a binary format selected in accordance with a protocol. The computer display or other selection input device can be substantially co-located with the telephone 134 (and thus in application the same user that operates the computer display or other input device can also generate the media device 134 data) and be coupled to the network 100 via the same gateway 104. Alternatively, the computer display or other input device can be at least one of not co-located with the telephone 134 and not coupled to the network via the same gateway (and thus the computer display or other input device in application would generally be operated by a person other than the user that generates the media device 134 data). This alternative structure is illustratively portrayed by the user input device 194 that is coupled to the gateway 108.

In an embodiment in which the user input device and the media device do not couple to the network through the same gateway, the user input device should transmit to the management unit 142 a proper identification of a call in progress and optionally a datum to identify an authorization to input data regarding a call unless the functionality of the user input device is limited to the specific media device. In an embodiment in which the user input device and the media device couple to the network through the same gateway, it could be presumed that the call is the call being transmitted from or received by the media device.

In an embodiment having a display device, the management unit 142 sends to a display device, illustratively portrayed as 194, at least one of a list of possible quality of service levels for a connection and possible bearer paths for a connection, for presentation on the display and from which the user can select a quality of service level or bearer path. In an embodiment, the list is presented to the user as a menu and selected according to a menu selection protocol well known to those skilled in the art of interactive computer system design.

In an embodiment, the user transmits a request for a specific quality of service level or defers to a default quality of service level that may be determined algorithmically. In an example of a user requesting a quality of service level from a third location within a network for a call between a first location and a second location, the media input device 186 coupled to the network from the media gateway 108 can request a quality of service level for the call between the endpoint media gateway 104 and endpoint media gateway 124, by properly identifying the call between the media gateway 104 and the media gateway 124 according to a protocol and authorization recognized by the management unit 142.

In block 208, the destination code binary format and quality of service binary format is transmitted by a gateway that is coupled to a media device, illustratively portrayed as the call control user interface integration circuit 128, through the media gateway 104 along the signaling path to the management unit 142 (or alternatively illustratively portrayed as the media gateway 108 described hereinabove). In another embodiment, if the quality of service level is not transmitted to the management unit 142, the management unit 142 supplies a default requested quality of service level that may be determined algorithmically.

In block 212, the management unit 142 sets up the call over the network 100 for a given quality of service. The management unit 142 commands a quality of service for the call along a bearer path according to a selected methodology. There is a mapping by the call agent from the quality of service level a user requests to the suitable characteristics of a transmission device to transmit the quality of service level. The management unit 142 preferably controls the quality of service level by commanding alternatively the packet transmission devices at an least one endpoint of the call, or the individual packet transmission devices along a selected bearer path determined by a selected quality of service level. In an embodiment well known to those skilled in the art of network telephony, the management unit 142 controls the quality of service level by programming a quality of service level or parameters into the endpoint transmission devices. These transmission devices just need the quality of service parameters set to match each other. The transmission devices do not play a part in transmitting quality of service parameters because they transmit only the bearer portion of a call. The call agent 142 transmits and receives quality of service capabilities. The mechanism to control the quality of service is separate from the mechanism to control the bearer path.

The preferred embodiment commands a quality of service level of a transmission by using the Resource Reservation Protocol (RSVP). The RSVP occupies the place of a transport protocol in the Open Systems Interconnection (OSI) model seven layer stack. The RSVP enables the reservation of resources for an end-to-end desired quality of service along a data path in only one direction from the destination (or receiver in RSVP terminology) packet transmission device, and then allow the packet transmission devices to schedule and prioritize packets to fulfill the commanded quality of Service level.

In an embodiment using the RSVP to select a data path commensurate with the commanded quality of service level for a call transmission in one direction, The management unit 142 sends to a receiving endpoint packet transmission device 124 the requested quality of service level and the sending gateway 104 address. The receiving endpoint packet transmission device 124 reserves a signaling path that can support the requested quality of service level if one is available and passes back to the management unit 142 the selected quality of service level. In the more general embodiment of the present invention during the call set-up, the management unit 142 exchanges capabilities about at least one of the gateways, the network speed, the available codecs, and the levels of supported quality of service according to the method of setting up the data path.

In block 216 the management unit 142 sends a billing event information for the start of the call to indicate the start of the call to the billing application 144 for the evaluation, generation, or the like, of the quality of service history, bill, cost, charge, price, value of the call, or the like depending upon the quality of service level of the call. The billing information can include the independent data the billing application requires in order to generate or evaluate a bill for a call for data that is not generated within the billing agent. The billing information specifically includes at least a datum representative of the quality of service level, and may additionally include in an embodiment a representation of a time or other characteristic that combines with a quality of service level representation to dynamically generate or evaluate a bill or the like for the call as a function of a dynamic quality of service level. In an embodiment, a network unit other than the management unit 142 sends at least a portion of the billing information to the billing application 144.

According to an illustrative scenario, that includes at least one change of quality of service for a given connection, in block 220 the management unit 142 receives a request to change the quality of service level of the call or alternatively generate a quality of service level selection algorithmically that in an embodiment depends upon a network status and in another embodiment depends upon a selected sequence of quality of service levels, and in another embodiment is in response to a default condition. The management unit 142 verifies the authorization of the requester and if the request is an authorized change, and in block 224 sets up the selected quality of service level in the network as has been described with reference to block 212.

In block 228, the management unit 142 sends the billing information for the changed quality of service billing event to the billing application 144 for the evaluation, generation, or the like, of the quality of service history, bill, cost, charge, price, value of the call, or the like depending upon the quality of service of the call. In an embodiment, a network unit other than the management unit 142 sends at least a portion of the billing information to the billing application 144. Blocks 220, 224, and 228 are repeated for each change of quality of service during the call.

In an illustrative example of the operation and design of the present invention for the illustrative network depicted in FIG. 1 and a one-way endpoint-to-endpoint transmission, a user illustratively picks up a touch-tone media device 134 and dials a call to a terminal having a telephone number identification that the user selects using the user input device 134 touch-pad. The telephone number is sent along a signaling path to the management unit 142 of the present invention. The management unit 142 commands a bearer path for the call at a default quality of service level which in this illustrative example is presumed to be level 1, a quality of service level commensurate with at most a voice-grade transmission, because the user did not illustratively request a specific quality of service level. It is presumed that the call receiving terminal is illustratively coupled to the gateway 124. The bearer path for this illustrative operation is the first bearer path which can provide the quality of service level 1. The management unit 142 sends to the billing application 144 a signal indicating an identification of the quality of service level of the call. The user input device as disclosed with reference to FIG. 2 could be a terminal coupled to a different gateway from the media device, or a non-touch-pad input device.

After a time, a user illustratively decides to transfer data at a higher bandwidth such as a signal having both a voice and a video component for a teleconferencing data transmission application, and requiring a quality of service level 3 connection. From the input device 194, the user requests from the management unit 142 across a signaling path, a list of available quality of service levels. The user includes in the request both an identification of the call and an optional authorization identification signal that the management unit 142 can use to verify for authorization, before the management unit 142 complies with the request. Assuming the request from the user input device was an authorized request, the management unit 142 in response to the request, and in accordance with a selected protocol disclosed with reference to FIGS. 1 and 2, determines the quality of service levels available for the specified call. These levels are illustratively level 1 across both the first, the second, and the third bearer paths; level 2 across both the first, the second, and the third bearer paths; level 3 across both the second and the third bearer paths; and level 4 across the third bearer path. These levels are transmitted across the signaling path to the user input device 194 for display, such as in the form of a selection menu. The user selects a quality of service level in the input device 194. In another embodiment, a user selects a quality of service level without a list of available quality of service levels, and makes a quality of service selection which is acted on by the management unit 142 if a bearer path can be set-up having the selected transmission quality of service level.

The selection of the quality of service level is transmitted across a signaling path from the user input device 194 to the management unit 142, wherein the management unit 142 commands the network to furnish the selected quality of service level which is illustratively level 4, wherein the bearer path 3 is set-up for transmission of the call. The management unit sends to the billing application 144 a signal containing an identification of the new quality of service level of the call. The call is transmitted at the newly selected transmission quality of service level until a user alternatively terminates the call, or changes the quality of service level again, at which time the management unit 142 commands the new quality of service level and sends a notification to the billing application 144.

Thus, a method and apparatus for selecting and setting-up a plurality of quality of service levels for a call has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense. Although a preferred embodiment of the invention has been illustrated and described, various alternatives, modifications and equivalents may be used. Therefore, the foregoing description should not be taken as limiting the scope of the inventions which are defined by the appended claims.

I claim:

1. A method of changing a quality of service level of a call in a network between a first endpoint gateway of the network and a second endpoint gateway of the network, from a first quality of service level to a second quality of service level, comprising:
a user input device coupled to the network sending a first signal to a management unit that is coupled to the network, the first signal indicating the second quality of service level for the call;
the management unit sending at least one second signal that indicates the first quality of service level for the call in response to the first signal, to at least one transmission device of the network;
the network configuring a bearer path for the call that has the second quality of service level, in response to the management unit sending the at least one second signal.

2. The method defined in claim 1 further including the management unit sending to a billing application a signal that indicates that the call has the second quality of service level.

3. The method defined in claim 2 wherein the management unit sending to a billing application is in response to at least one of the user input device sending the first signal, the management unit sending the at least one second signal, and the network configuring a bearer path for the call that has the second quality of service.

4. The method defined in claim 1 further including the management unit sending to a billing application a signal that indicates substantially a time that the call has changed from the first quality of service level to the second quality of service level.

5. The method defined in claim 1 wherein the at least one transmission device includes at least one of the first endpoint gateway and the second endpoint gateway.

6. The method defined in claim 1 wherein each of the transmission devices is an endpoint gateway of the call.

7. The method defined in claim 1 wherein the user input device is a touch-telephone.

8. The method defined in claim 1 wherein the user input device is a tone device.

9. The method defined in claim 1 wherein the user input device is a digital signal transmitter.

10. The method defined in claim 1 wherein the user input device is coupled to the network from one of a non-endpoint gateway and an endpoint gateway.

11. The method defined in claim 1 further including the call agent sending to a billing application at least one of
a signal representing the second quality of service level and substantially a time that the call has changed from the first quality of service level to the second quality of service level, and
a signal representing the second quality of service level and an indication of the duration of the first quality of service level.

12. The method defined in claim 1 further including the management unit sending to the user input device an identification of at least one of a quality of service levels available for the call before the user input device sending the first signal to the management unit.

13. The method defined in claim 1 further including the management unit receiving from the user input device a signal for the management unit to send an identification of at least one of a quality of service levels available for the call; and the management unit sending to the user input device the identification of at least one of a quality of service levels available for the call in response to receiving from user input device the signal for the management unit to send an identification of at least one of a quality of service levels available for the call, before the user input device sending the first signal to the management unit.

14. A method of changing a quality of service level of a call in a network between a first endpoint gateway of the network and a second endpoint gateway of the network that is configured to transmit a first quality of service level, to a changed quality of service level, comprising a management unit sending at least one first signal to at least one transmission device of the network that commands a reconfiguration to transmit the call at the changed quality of service level between the first endpoint gateway of the network and the second endpoint gateway in response to the first signal.

15. The method defined in claim 14 further including a user input device that is coupled to the network sending a second signal to the management unit across the network that indicates the changed quality of service level for the call; and wherein the management unit sends the at least one first signal to the at least one transmission device in response to the input device sending the second signal to the management unit.

16. The method defined in claim 15 further including the management unit sending to the user input device an identification of at least one of a quality of service levels available for the call before the user input device sending the second signal to the management unit.

17. The method defined in claim 16 further including the management unit receiving from the user input device a signal to receive from the management unit an identification of at least one of a quality of service levels available for the call; and the management unit sending to the user input device the identification of at least one of a quality of service levels available for the call in response to receiving from user input device the signal to receive an identification of at least one of a quality of service levels available for the call.

18. The method defined in claim 14 further including the management unit generating the changed quality of service level at least one of algorithmically and from a stored value representing the changed quality of service level.

19. The method defined in claim 14 wherein the at least one transmission device includes at least one of the first endpoint gateway and the second endpoint gateway.

20. The method defined in claim 14 further including the management unit sending to a billing application a signal that reflects the changed quality of service level.

21. A network management unit that includes:
a first circuit to generate a first signal to indicate a first quality of service level for a call having a second quality of service level between at least two gateway endpoints of a network; and
a second circuit to send the first signal to the network to command the network to change the quality of service level to the first quality of service level.

22. The network management unit defined in claim 21 wherein the first circuit includes a programmed computing device and wherein the first circuit is to generate the first signal in response to a program executed on the programmed computing device.

23. The network management unit defined in claim 21 further including a third circuit to receive a second signal from the network indicating the first quality of service level; and wherein the first circuit is to generate the first signal in response to receiving the second signal.

24. The network management unit defined in claim 21 further including a fourth circuit to generate a second signal for a billing application to indicate that the call has the first quality of service in response to one of the first circuit generating the first signal, the second circuit sending the first signal, and the network management unit receiving a third signal from the network.

25. The network management unit defined in claim 24 wherein the fourth circuit includes a programmed computing device and wherein the fourth circuit is to generate the second signal in response to a program executed on the programmed computing device.

26. The network management unit defined in claim 21 further including:
a fifth circuit to receive from at least one transmission device of the network a second signal to indicate an identification of at least one of an available quality of service levels for the call.

27. The network management unit defined in claim 21 further including:
a sixth circuit to generate a second signal to indicate an identification of at least one of an available quality of service levels for the call; and
a seventh circuit to send the second signal to the network to display on a user terminal coupled to the network the available quality of service levels.

28. The network management unit defined in claim 21 wherein the first circuit is to generate the indication of the first quality of service level in response to at least one of receiving an indication of a first quality of service level from a user input device coupled to the network, algorithmically, and from a stored value that indicates the first quality of service level.

30. A machine-readable medium that provides instructions, which when executed by at least one processor, cause said processor to perform operations comprising
generating a first signal to indicate a first quality of service level for a call having a second quality of service level between at least two gateway endpoints of a network; and
sending the first signal to the network to command the network to change the quality of service level from the second quality of service level to the first quality of service level.

31. The operations defined in claim 30 further including a receiving a second signal from the network indicating the first quality of service level; and wherein the generating the first circuit is in response to the received second signal.

32. The operations defined in claim 30 further including generating a second signal for a billing application to indicate that the call has the first quality of service in response to one of the generating the first signal first circuit, the sending the first signal, and the network management unit receiving a third signal from the network.

33. The operations defined in claim 30 further including:
receiving from at least one transmission device of the network a second signal to indicate an identification of at least one of an available quality of service levels for the call.

34. The operations defined in claim 30 further including:
generating a second signal to indicate an identification of at least one of an available quality of service levels for the call; and
sending the second signal to the network to display on a user terminal coupled to the network the available quality of service levels.

35. The operations defined in claim 30 wherein the generating the first signal first circuit is in response to at least one of receiving an indication of a first quality of service level from a user input device coupled to the network, algorithmically, and from a stored value that indicates the first quality of service level.
